(19) United States
(12) Patent Application Publication
(10) Pub. No.: US 2025/0162361 A1
(43) Pub. Date: May 22, 2025

(54) PIVOT MECHANISM AND CARRYING VEHICLE

(71) Applicant: EXEDY Corporation, Osaka (JP)

(72) Inventor: Taichi KITAMURA, Osaka (JP)

(21) Appl. No.: 18/923,907

(22) Filed: Oct. 23, 2024

(30) Foreign Application Priority Data
Nov. 22, 2023 (JP) 2023-198313

(51) Int. Cl. B60D 1/34

(52) U.S. Cl. CPC B60D 1/34

(57) ABSTRACT

A pivot mechanism for use in connection with a carried (e.g., towed or pushed) vehicle includes a base portion, a pivot portion, and a restoration mechanism. The pivot portion is attached to the base portion in a pivotable manner. The restoration mechanism is configured to generate a restoring force in accordance with a pivot angle of the pivot portion to restore the pivot portion to a neutral state when the pivot angle of the pivot portion falls within a first angular range.

### CROSS-REFERENCE TO RELATED APPLICATIONS

This application is based on and claims the priority benefit of Japanese application 2023-198313 filed on Nov. 22, 2023, the contents of which are incorporated herein by reference.

### TECHNICAL FIELD

The claimed invention relates to a pivot mechanism and a carrying vehicle.

### BACKGROUND

A carrying vehicle (electric towing vehicle, automated guided vehicle (AGV), etc.) is configured to be joined to a carried vehicle (e.g., cart) to tow and carry the carried vehicle (Japan Laid-open Patent Application Publication No. 2018-108795). The carrying vehicle is joined to the carried vehicle through a pivot mechanism such that both the carrying vehicle and the carried vehicle are pivotable relative to each other, whereby the carrying vehicle can be turned when carrying the carried vehicle.

In traveling of the carrying vehicle, if the carried vehicle is pushed by the carrying vehicle with the pivot mechanism being pivoted, there is a chance that the carried vehicle will be undesirably oriented in a direction orthogonal to a moving direction and thereby be hindered from smoothly traveling in the moving direction.

### SUMMARY OF THE INVENTION

It is an object of the claimed invention to provide a pivot mechanism, whereby smooth traveling of a carried vehicle is made possible.

A pivot mechanism according to a first aspect includes a base portion, a pivot portion, and a restoration mechanism. The pivot portion is attached to the base portion in a pivotable manner. The restoration mechanism is configured to generate a restoring force in accordance with a pivot angle of the pivot portion to restore the pivot portion to a neutral state when the pivot angle of the pivot portion falls in a first angular range.

According to the configuration, the pivot portion is restored to the neutral state by the restoration mechanism; hence, when a carrying vehicle and a carried vehicle are joined through the pivot mechanism, it is made possible to inhibit occurrence of such an undesirable situation that when the carrying vehicle travels while pushing the carried vehicle, the carried vehicle is oriented in a direction orthogonal to the traveling direction of the carrying vehicle. As a result, smooth traveling of the carried vehicle is made possible.

A pivot mechanism according to a second aspect relates to the pivot mechanism according to the first aspect and is configured as follows. When the pivot angle falls in a second angular range greater in the pivot angle than the first angular range, the restoration mechanism is configured not to generate the restoring force. When the pivot angle falls in the second angular range, the restoration mechanism is alternatively configured to generate the restoring force smaller in magnitude than when the pivot angle falls in the first angular range. According to the configuration, it is made possible to inhibit occurrence of such a situation that turning is made difficult by the restoring force.

A pivot mechanism according to a third aspect relates to the pivot mechanism according to the second aspect and is configured as follows. When the pivot angle falls in a third angular range between the first angular range and the second angular range, the restoration mechanism is configured to generate the restoring force reduced in magnitude with increase in the pivot angle.

A pivot mechanism according to a fourth aspect relates to the pivot mechanism according to any of the first to third aspects and is configured as follows. When the pivot angle falls in the first angular range, the restoration mechanism is configured to generate the restoring force increased in magnitude with increase in the pivot angle.

A pivot mechanism according to a fifth aspect relates to the pivot mechanism according to any of the first to fourth aspects and is configured as follows. The restoration mechanism includes a cam surface, a cam follower, and an urging member. The cam surface is provided on either of the pivot portion and the base portion. The cam follower is in contact with the cam surface. The urging member urges the cam follower along an imaginary straight line connecting a pivot axis of the pivot portion and the cam follower.

A pivot mechanism according to a sixth aspect relates to the pivot mechanism according to the fifth aspect and is configured as follows. The cam surface is provided on the pivot portion. The cam surface includes a first cam-surface segment. The first cam-surface segment comes in contact with the cam follower when the pivot angle falls in the first angular range. The first cam-surface segment is shaped to be increased in distance thereto from the pivot axis with increase in distance thereto from a neutral point. The neutral point is set as a point of contact with the cam follower on the first cam-surface segment in the neutral state of the pivot portion.

A pivot mechanism according to a seventh aspect relates to the pivot mechanism according to the fifth aspect and is configured as follows. The cam surface is provided on the base portion. The urging member is attached to the pivot portion. The cam surface includes a first cam-surface segment. The first cam-surface segment comes in contact with the cam follower when the pivot angle falls in the first angular range. The first cam-surface segment is shaped to be reduced in distance thereto from the pivot axis with increase in distance thereto from a neutral point. The neutral point is set as a point of contact with the cam follower on the first cam-surface segment in the neutral state of the pivot portion.

A pivot mechanism according to an eighth aspect relates to the pivot mechanism according to the sixth or seventh aspect and is configured as follows. The cam surface includes a second cam-surface segment. The second cam-surface segment comes in contact with the cam follower when the pivot angle falls in a second angular range greater in the pivot angle than the first angular range. The second cam-surface segment is configured such that when the second cam-surface segment comes in contact with the cam follower, a tangent line drawn at a point of contact with the cam follower on the second cam-surface segment is oriented orthogonal to a straight line connecting the point of contact and the pivot axis.

A pivot mechanism according to a ninth aspect relates to the pivot mechanism according to any of the sixth to eighth aspects and is configured as follows. The cam surface includes a second cam-surface segment. The second cam-surface segment comes in contact with the cam follower when the pivot angle falls in a second angular range greater in the pivot angle than the first angular range. The second cam-surface segment is shaped to be constant in distance therefrom to the pivot axis.

A pivot mechanism according to a tenth aspect relates to the pivot mechanism according to the eighth or ninth aspect and is configured as follows. The cam surface includes a third cam-surface segment. The third cam-surface segment comes in contact with the cam follower when the pivot angle falls in a third angular range between the first angular range and the second angular range. The first cam-surface segment is made in the shape of a circular arc recessed toward the pivot axis in a view along the pivot axis. The third cam-surface segment is made in the shape of a circular arc bulged in a direction away from the pivot axis in the view along the pivot axis.

A carrying vehicle according to an eleventh aspect includes a carrying vehicle body and the pivot mechanism recited in any of the first to tenth aspects. The carrying vehicle body includes a prime mover and a drive wheel. The pivot mechanism is attached to the carrying vehicle body.

Overall, according to the claimed invention, it is made possible to smoothly travel a carried vehicle.

### BRIEF DESCRIPTION OF THE DRAWINGS

FIG. 1 is a side view of a carrying vehicle in accordance with the claimed invention.

FIG. 2 is a side view of the carrying vehicle, from which a frame is detached in part.

FIG. 3 is an enlarged perspective view of the carrying vehicle.

FIG. 4 is a cross-sectional view of a pivot mechanism used in the carrying vehicle shown in FIG. 1.

FIG. 5 is a plan view of the pivot mechanism, from which a base portion is detached in part.

FIG. 6 is a plan view of the pivot mechanism in a condition that a pivot angle falls in a first angular range.

FIG. 7 is a plan view of the pivot mechanism in a condition that the pivot angle falls in a second angular range.

FIG. 8 is a plan view of the pivot mechanism in a condition that the pivot angle falls in a third angular range.

FIG. 9 is a plan view of a pivot mechanism according to a modification of the embodiment illustrated in FIGS. 1-8.

FIG. 10 is a plan view of a pivot mechanism according to another modification of the embodiment illustrated in FIGS. 1-8.

FIG. 11 is a plan view of a pivot mechanism according to yet another modification of the embodiment illustrated in FIGS. 1-8.

### DETAILED DESCRIPTION

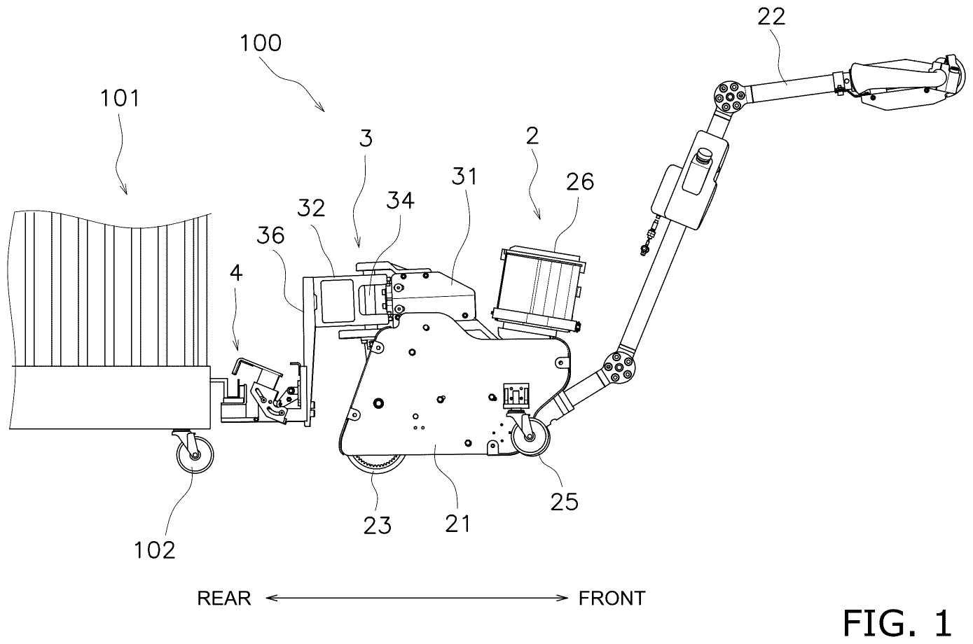

A pivot mechanism 3 according to the presently preferred embodiment, and a carrying vehicle 100 in which the same is installed, will be explained with reference to the drawings. It should be noted that in the following explanation, the term “front” refers to a direction that the carrying vehicle 100 is moved, while towing a carried vehicle 101, whereas the term “rear” refers to a direction that the carrying vehicle 100 is moved, while pushing the carried vehicle 101. In other words, the right side in FIG. 1 corresponds to the front side, whereas the left side in FIG. 1 corresponds to the rear side.

### Carrying Vehicle

FIG. 1 is a side view of the carrying vehicle 100. It should be noted that FIG. 1 shows the carrying vehicle 100 that has not been joined to the carried vehicle 101. As shown in FIG. 1, the carrying vehicle 100 is configured to be joined to the carried vehicle 101 to tow the carried vehicle 101. It should be noted that the carrying vehicle 100 is also capable of pushing the carried vehicle 101. The carrying vehicle 100 is driven by a human drive force and an assist force generated by a prime mover 24. It should be noted that the carrying vehicle 100 can travel by either the human drive force alone or the drive force generated by the prime mover 24 alone. It should be noted that in the presently preferred embodiment, a cage cart is exemplified as the carried vehicle 101; however, a variety of vehicles other than the cage cart (a cart, a stretcher, a wheelchair, etc.) can be exemplified as the carried vehicle 101.

The carrying vehicle 100 includes a carrying vehicle body 2, the pivot mechanism 3, and a clamp mechanism 4. The carried vehicle 101, carried by the carrying vehicle 100, includes a plurality of wheels 102.

### Carrying Vehicle Body

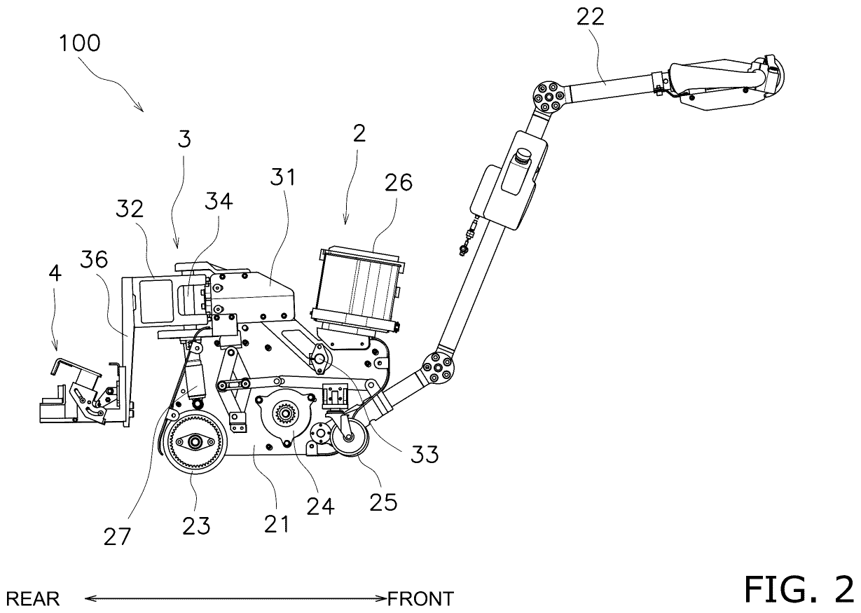

FIG. 2 is a side view of the carrying vehicle 100, from which a frame 21 of the carrying vehicle body 2 is detached in part in FIG. 1. As shown in FIGS. 1 and 2, the carrying vehicle body 2 includes the frame 21, an operating member 22, a drive wheel 23, the prime mover 24, a driven wheel 25, a battery 26, and an urging member 27.

The operating member 22 is attached to the frame 21. The operating member 22 is configured to receive the human drive force forwardly or rearwardly inputted thereto by a user. For example, a handle to be held by the user is attached to the distal end of the operating member 22.

The drive wheel 23, the prime mover 24, the driven wheel 25, the battery 26, and the urging member 27 are attached to the frame 21. The drive wheel 23 is driven by the prime mover 24. The prime mover 24 is, for instance, an electric motor. The prime mover 24 is supplied with electricity from the battery 26.

The urging member 27 is configured to urge the drive wheel 23 downward. The urging member 27 is disposed between the pivot mechanism 3 (specifically, a base portion 31 thereof) and the drive wheel 23. The urging member 27 urges the pivot mechanism 3 and the drive wheel 23 apart from each other. The urging member 27 is attached at the upper end thereof to the pivot mechanism 3, while being attached at the lower end thereof to the frame 21. The urging member 27 urges the drive wheel 23 downward through the frame 21. The urging member 27 is, for instance, a coil spring. The urging member 27 is installed such that a compressed state thereof is made when the carried vehicle 101 is joined to the carrying vehicle 100.

### Pivot Mechanism

The pivot mechanism 3 is attached to an upper part of the carrying vehicle body 2. The pivot mechanism 3 is attached to the carrying vehicle body 2 to be pivotable in an up-and-down direction. The pivot mechanism 3 includes the base portion 31, a pivot portion 32, an arm 36, and a restoration mechanism 37.

The base portion 31 is attached to the carrying vehicle body 2. Specifically, the base portion 31 is attached to the carrying vehicle body 2 to be pivotable in the up-and-down direction. It should be noted that the base portion 31 is pivotable in the up-and-down direction along a vertical plane extending in a back-and-down direction. The base portion 31 is attached to the frame 21 through a first pivot shaft 33. The first pivot shaft 33 extends in a right-and-left direction. Besides, the base portion 31 is attached to the frame 21 through the urging member 27 and so forth.

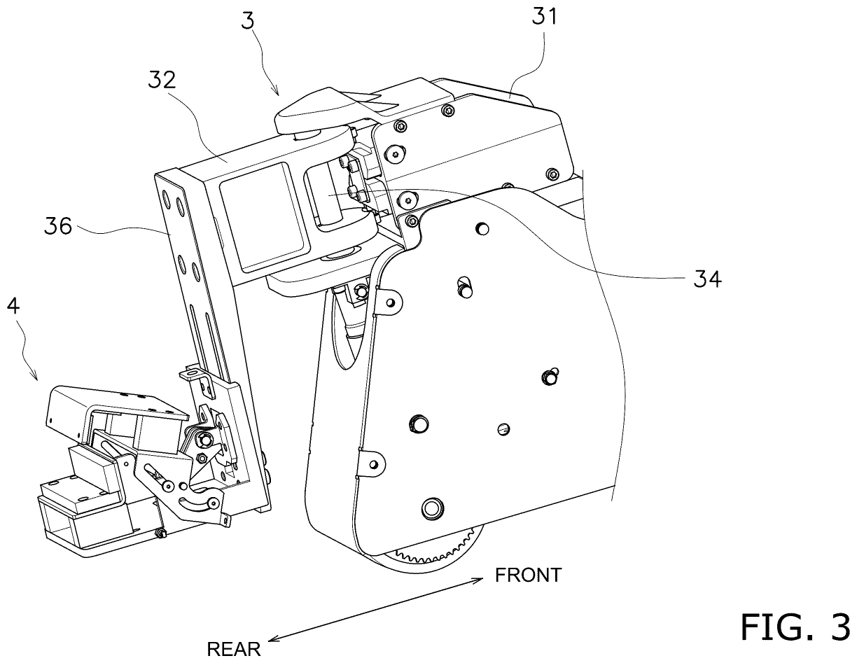

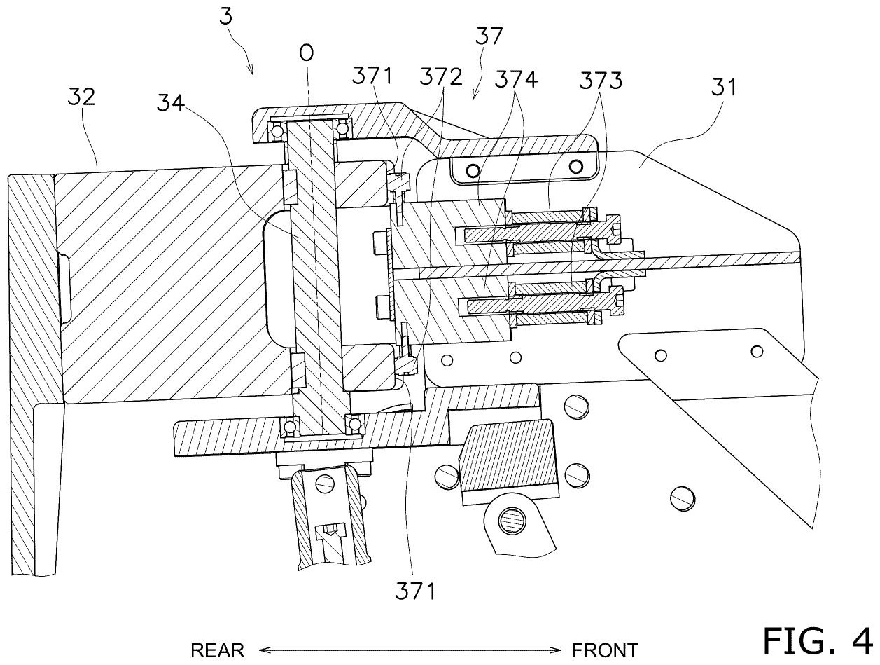

FIG. 3 is an enlarged perspective view of the carrying vehicle 100, whereas FIG. 4 is a cross-sectional view of the pivot mechanism 3. As shown in FIGS. 3 and 4, the pivot portion 32 is disposed behind the base portion 31. The pivot portion 32 is attached to the base portion 31 to be pivotable in a horizontal direction. Specifically, the pivot portion 32 is attached to the base portion 31 to be pivotable in the right-and-left direction. The pivot portion 32 is attached to the base portion 31 through a second pivot shaft 34. The second pivot shaft 34 extends in the up-and-down direction. The pivot portion 32 is pivotable about a pivot axis O. The pivot axis O is identical to the center axis of the second pivot shaft 34.

The arm 36 extends downward from the pivot portion 32. The arm 36 is fixed to the pivot portion 32. In other words, the arm 36 is unitarily pivoted with the pivot portion 32. The arm 36 may be fixed to the pivot portion 32 by bolts and so forth. The arm 36 is provided as a member separate from the pivot portion 32; however, the arm 36 may be integrated with the pivot portion 32 as a single member.

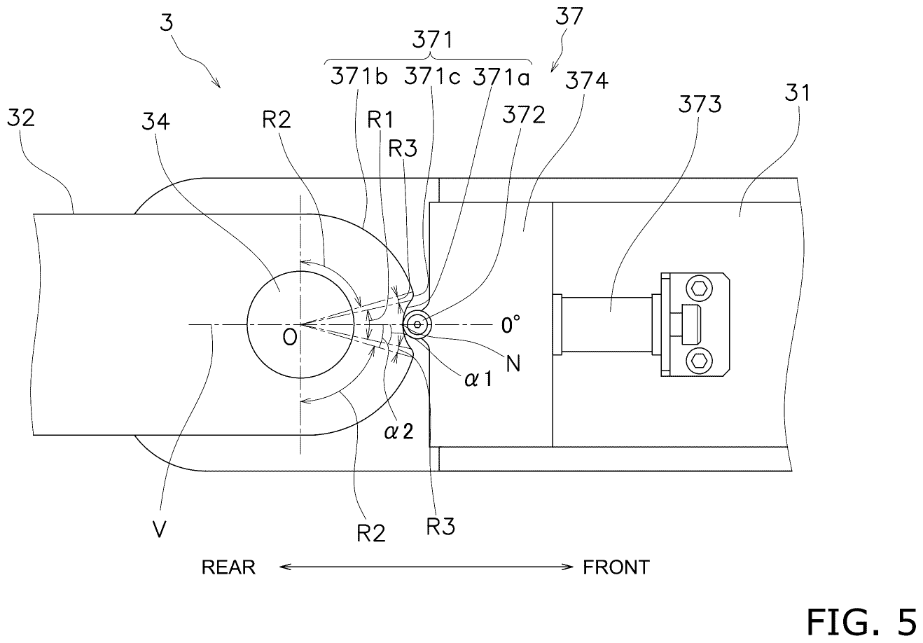

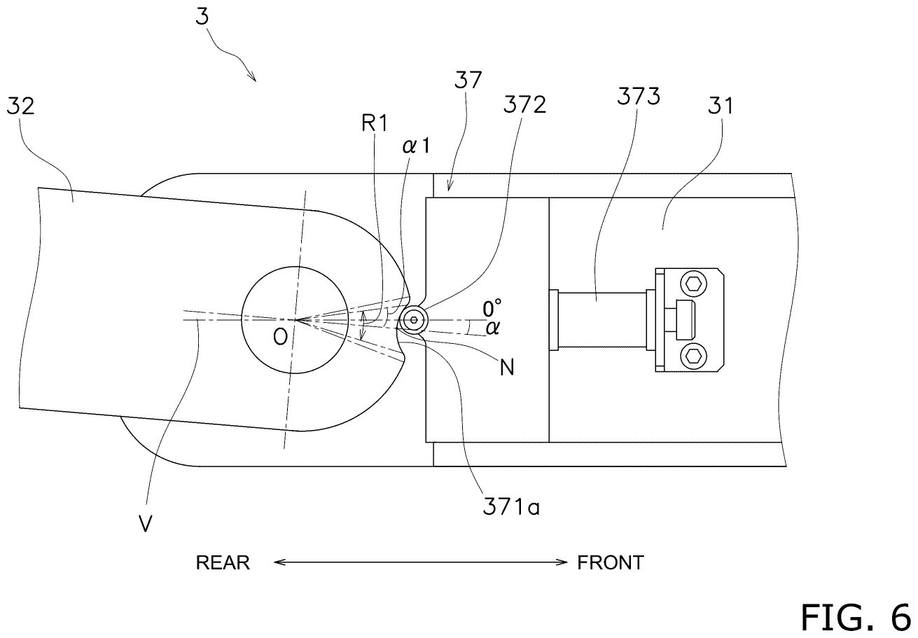

FIG. 5 is a plan view of the pivot mechanism 3, from which the base portion 31 is detached in part. FIG. 5 shows the pivot mechanism 3 in a condition that the pivot portion 32 is in a neutral state (pivot angle α=0°). (See FIGS. 6-9 for use of the label α to indicate different angular amounts by which the pivot portion 32 has pivoted about the pivot axis O, i.e., different pivot angles.) As shown in FIGS. 4 and 5, the restoration mechanism 37 includes a pair of cam surfaces 371 (one upper and one lower), a pair of cam followers 372 (one upper and one lower), and a pair of urging members 373 (one upper and one lower). Additionally, the restoration mechanism 37 includes a pair of intermediate members 374 (one upper and one lower). It should be noted that the number for each of the cam surfaces 371, the cam followers 372, the urging members 373, and the intermediate members 374 may be less than two (i.e., one) or more than two.

The cam surfaces 371 are provided on the pivot portion 32. More particularly, the cam surfaces 371 are provided on a surface of the pivot portion 32 facing the base portion 31. In other words, the cam surfaces 371 face forward. Each cam surface 371 is composed of a first cam-surface segment 371a, a second cam-surface segment 371b, and a third cam-surface segment 371c.

The cam followers 372 are in contact with the cam surfaces 371 on a one-to-one basis. Each cam follower 372 is urged by an urging member to press against each cam surface 371. Each cam follower 372 is attached to each intermediate member 374. Each cam follower 372 may be made in the shape of a column. Each cam follower 372 extends in the up-and-down direction. Each cam follower 372 may or may not roll on each cam surface 371.

The urging members 373 are attached to the base portion 31. Each urging member 373 urges each cam follower 372 along an imaginary straight line V connecting the pivot axis O of the pivot portion 32 and each cam follower 372. In the presently preferred embodiment, each urging member 373 urges each cam follower 372 toward the pivot axis O. Because of this, each cam follower 372 presses against each cam surface 371 in a direction toward the pivot axis O.

Each urging member 373 urges each cam follower 372 through each intermediate member 374. Each urging member 373 is, for instance, a coil spring. Each urging member 373 extends in the back-and-forth direction. When the pivot portion 32 is in the neutral state, each urging member 373 is preferably in a compressed state but may be in a state of natural length.

FIG. 6 is a plan view of the pivot mechanism 3, from which the base portion 31 is detached in part. FIG. 6 shows the pivot mechanism 3 in a condition that the pivot angle a of the pivot portion 32 falls within a first angular range R1 that extends counterclockwise (and clockwise as well) from the pivot angle α=0° position to a first pivot-angle value of al. The first pivot-angle value α1 may, for instance, be on the order of 10° to 20°.

As illustrated in FIG. 6, when the pivot angle α falls within the first angular range R1 (i.e., when the pivot angle α falls in a range of 0° to α1), the restoration mechanism 37 generates a restoring force that acts to restore the pivot portion 32 to the neutral state. The restoring force is herein generated as a function of the pivot angle α of the pivot portion 32. More specifically, for pivoting within the angular range R1, the restoration mechanism 37 generates a restoring force that increases in magnitude with increase in the pivot angle α.

When the pivot angle α of the pivot portion 32 falls within the first angular range R1, each cam follower 372 is in contact with the first cam-surface segment 371a. In other words, the restoration mechanism 37 is configured to generate the restoring force that increases in magnitude with increase in the pivot angle α when each cam follower 372 is in contact with the first cam-surface segment 371a.

The first cam-surface segment 371a is shaped to be increased in distance thereto from the pivot axis O with increase in distance thereto from a neutral point N. (The neutral point N refers to a point of contact with each cam follower 372 on the first cam-surface segment 371a when the pivot portion 32 is in the neutral state.) Specifically, the first cam-surface segment 371a is shaped to be recessed toward the pivot axis O. The first cam-surface segment 371a is made in the shape of a circular arc in the plan view. With the first cam-surface segment 371a configured as described above, each urging member 373 is increased in displacement with increase in the pivot angle α, whereby the restoring force is increased in magnitude.

As illustrated in FIG. 5, when each cam follower 372 is in contact with the first cam-surface segment 371a at the neutral point N, the restoring force is not generated. In other words, a tangent line drawn at the neutral point N on the first cam-surface segment 371a is oriented orthogonal to a straight line connecting the neutral point N and the pivot axis O.

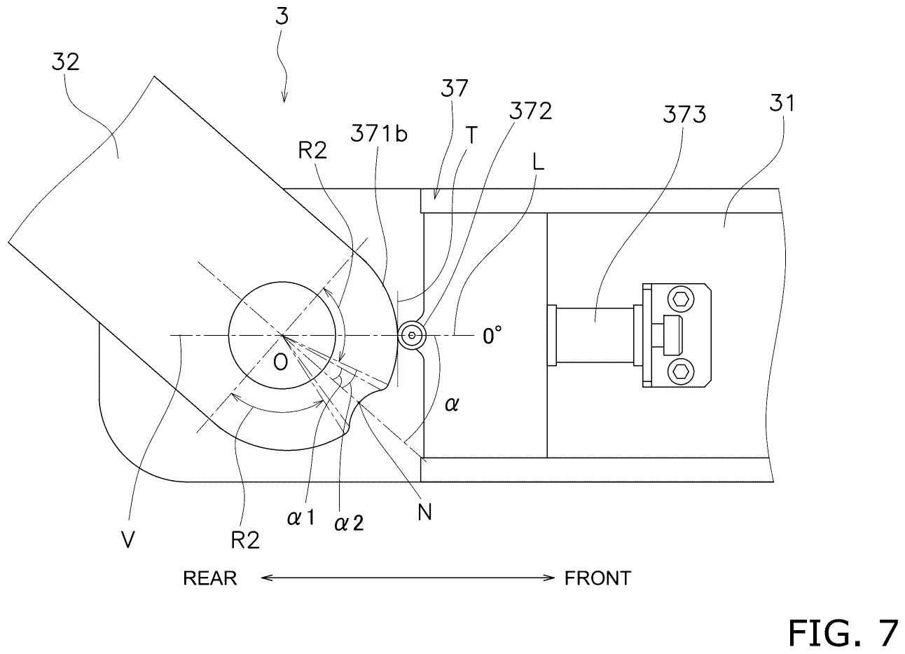

FIG. 7 is a plan view of the pivot mechanism 3 from which the base portion 31 is detached in part. FIG. 7 shows the pivot mechanism 3 in a condition that the pivot angle α falls within a second angular range R2 in which the pivot angle α equals or exceeds a second pivot-angle value α2, with the second pivot-angle value α2 being greater than the first pivot-angle value α1. (In other words, there is an angular “gap” between the first pivot-angle value al and the second pivot-angle value α2.) More particularly, the pivot angle α in the second angular range R2 falls in a range of greater than or equal to the second pivot angle α2 up to 90°. The second angular range R2 extends counterclockwise (and clockwise as well), for instance, approximately from the second pivot angle α2 to 90°.

As illustrated in FIG. 7, the restoration mechanism 37 is configured so as not to generate a restoring force when the pivot angle α of the pivot portion 32 falls in the second angular range R2, i.e., when the pivot angle α falls in a range of α2 to 90°. When the pivot angle α of the pivot portion 32 falls in the second angular range R2, each cam follower 372 is in contact with the second cam-surface segment 371b. In other words, the restoration mechanism 37 is configured so as not to generate a restoring force when each cam follower 372 is in contact with the second cam-surface segment 371b.

The second cam-surface segment 371b is shaped to be constant in distance therefrom to the pivot axis O regardless of the pivot angle α. In other words, the second cam-surface segment 371b is made in the shape of a circular arc about the pivot axis O. Because of this, a tangent line T, drawn at a point of contact with each cam follower 372 on the second cam-surface segment 371b (hereinafter referred to as “the point of contact”), is oriented orthogonal to a straight line L connecting the point of contact and the pivot axis O. Because of this, when each cam follower 372 is in contact with the second cam-surface segment 371b, a restoring force is not generated.

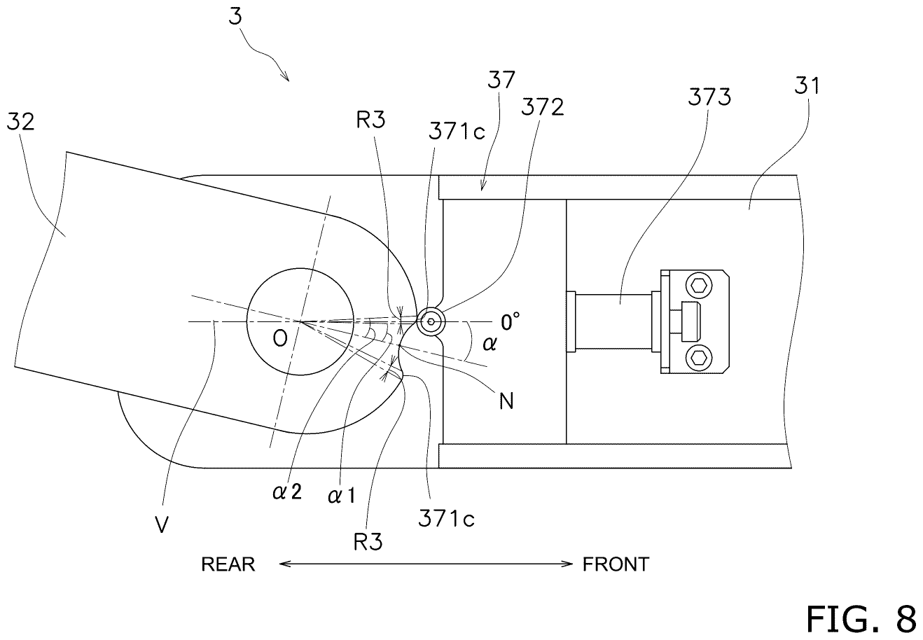

FIG. 8 is a plan view of the pivot mechanism 3, from which the base portion 31 is detached in part. FIG. 8 shows the pivot mechanism 3 in a condition that the pivot angle α falls within a third angular range R3. It should be noted that the third angular range R3 is a range interposed between the first angular range R1 and the second angular range R2. In other words, the pivot angle α in the third angular range R3 is greater than α1 and less than α2.

As illustrated in FIG. 8, when the pivot angle α falls within the third angular range R3, the restoration mechanism 37 generates a restoring force that decreases in magnitude as the pivot angle α increases. When the pivot angle α falls within the third angular range R3, each cam follower 372 is in contact with the third cam-surface segment 371c.

In other words, the restoration mechanism 37 generates the restoring force that decreases in magnitude with increase in the pivot angle α when each cam follower 372 is in contact with the third cam-surface segment 371c. The third cam-surface segment 371c is made in the shape of a circular arc bulged in a direction away from the pivot axis O in the plan view. The third cam-surface segment 371c smoothly connects the first cam-surface segment 371a and the second cam-surface segment 371b.

### Clamp Mechanism

As shown in FIGS. 1 to 3, the clamp mechanism 4 is attached to the carrying vehicle body 2 through the pivot mechanism 3. The clamp mechanism 4 is attached to the distal end (lower end) of the arm 36. The clamp mechanism 4 is configured to be movable with respect to the arm 36 in the up-and-down direction. For example, the clamp mechanism 4 is fixed to the arm 36 by a plurality of bolts and so forth and is made movable with respect to the arm 36 in the up-and-down direction by loosening the bolts.

The clamp mechanism 4 is configured to clamp the carried vehicle 101. The clamp mechanism 4 clamps an outer peripheral part of the carried vehicle 101.

### Modifications

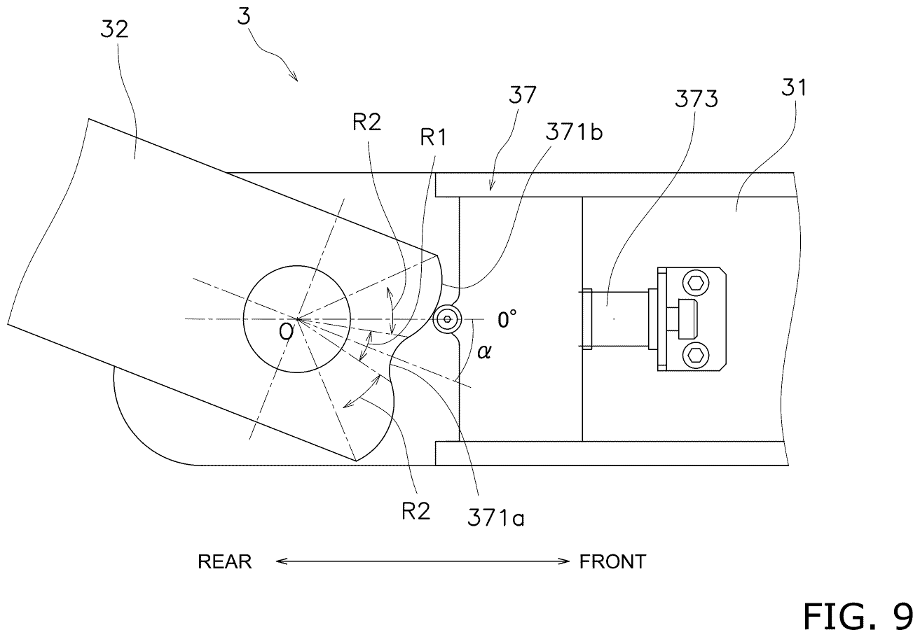

One preferred embodiment of the claimed invention has been described above. However, the claimed invention is not limited to the above, and a variety of changes can be made without departing from the scope and spirit of the claimed invention. It should be noted that respective modifications to be described are applicable simultaneously.
(a) In the preferred embodiment described above, the base portion 31 of the pivot mechanism 3 is attached to the carrying vehicle body 2 to be pivotable in the up-and-down direction; alternatively, the base portion 31 may be fixed to the carrying vehicle body 2. Besides, in this case, the base portion 31 may be integrated with the carrying vehicle body 2. For example, the base portion 31 may be integrated with the frame 21 as a single member.
(b) In the preferred embodiment described above, the restoration mechanism 37 is configured so as not to generate the restoring force when the pivot angle α falls in the second angular range R2; however, the restoration mechanism 37 is not limited in configuration to this. For example, as illustrated in FIG. 9, the restoration mechanism 37 may be configured to generate a restoring force when the pivot angle α falls in the second angular range R2. Here, the restoring force generated when the pivot angle α falls in the second angular range R2 is smaller in magnitude than that which is generated when the pivot angle α falls in the first angular range R1.

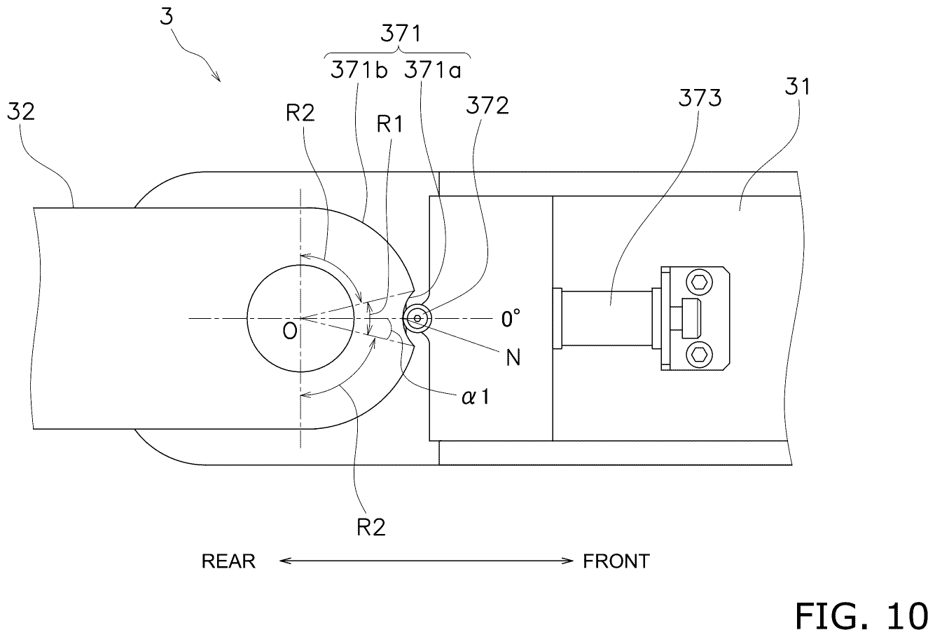

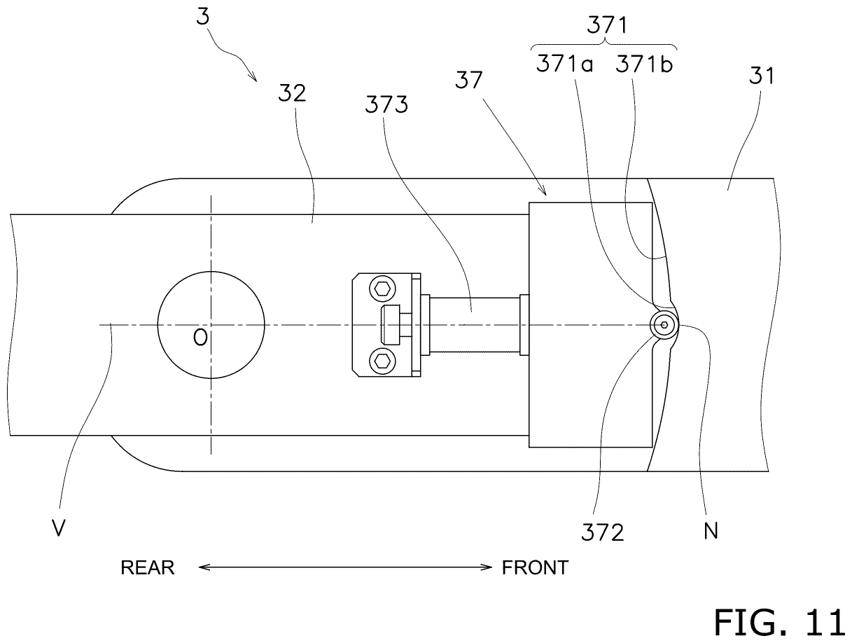

In this case, the second cam-surface segment 371b is made, for instance, in the shape of a circular arc bulged in a direction away from the pivot axis O. In other words, the second cam-surface segment 371b is opposite in bulged direction to the first cam-surface segment 371a.
(c) As illustrated in FIG. 10, each cam surface 371 may exclude the third cam-surface segment 371c. In other words, there may be no third angular range R3 interposed between the first angular range R1 and the second angular range R2 in the restoration mechanism 37.
(d) In the preferred embodiment described above, each cam surface 371 is provided on the pivot portion 32, whereas each urging member 373 is attached to the base portion 31; however, the restoration mechanism 37 is not limited in configuration to this. For example, as shown in FIG. 11, each cam surface 371 may be provided on the base portion 31, whereas each urging member 373 may be attached to the pivot portion 32.

In this case, each cam surface 371 is provided on a surface facing the pivot axis O in the base portion 31. The first cam-surface segment 371a is recessed on the base portion 31 to be away from the pivot axis O. The first cam-surface segment 371a is made in the shape of a circular arc in the plan view. The first cam-surface segment 371a is curved to be reduced in distance thereto from the pivot axis O with increase in distance thereto from the neutral point N.

The second cam-surface segment 371b is made in the shape of a circular arc about the pivot axis O. In other words, the second cam-surface segment 371b is shaped to be constant in distance therefrom to the pivot axis O regardless of the pivot angle α. The second cam-surface segment 371b is greater in curvature radius than the first cam-surface segment 371a.

### LIST OF REFERENCE NUMERALS

2: Carrying vehicle body, 23: Drive wheel, 24: Prime mover, 3: Pivot mechanism, 31: Base portion, 32: Pivot portion, 37: Restoration mechanism, 371: Cam surface, 371; 371a: First cam-surface segment, 371b: Second cam-surface segment, 371c: Third cam-surface segment, 372: Cam follower, 373: Urging member, 100: Carrying vehicle

1. A pivot mechanism, comprising:
a base portion;
a pivot portion attached to the base portion in a pivotable manner; and
a restoration mechanism configured to generate a restoring force the magnitude of which varies in accordance with a pivot angle of the pivot portion and that acts to restore the pivot portion to a neutral state when the pivot angle of the pivot portion falls in a first angular range.

2. The pivot mechanism according to claim 1, wherein the restoration mechanism is configured such that when the pivot angle falls in a second angular range greater in the pivot angle than the first angular range, the restoration mechanism either does not generate a restoring force or generates a restoring force that is smaller in magnitude than the restoring force generated when the pivot angle falls in the first angular range.

3. The pivot mechanism according to claim 2, wherein the restoration mechanism is configured such that when the pivot angle falls in a third angular range between the first angular range and the second angular range, the restoration mechanism generates a restoring force that decreases in magnitude with increase in the pivot angle.

4. The pivot mechanism according to claim 1, wherein the restoration mechanism is configured such that when the pivot angle falls in the first angular range, the restoration mechanism generates a restoring force that increases in magnitude with increase in the pivot angle.

5. The pivot mechanism according to claim 1, wherein the restoration mechanism includes
a cam surface provided on either of the pivot portion and the base portion,
a cam follower in contact with the cam surface, and
an urging member urging the cam follower along an imaginary straight line connecting a pivot axis of the pivot portion and the cam follower.

6. The pivot mechanism according to claim 5, wherein
the cam surface is provided on the pivot portion,
the cam surface includes a first cam-surface segment, the first cam-surface segment coming in contact with the cam follower when the pivot angle falls in the first angular range, and
the first cam-surface segment is shaped to be increased in distance thereto from the pivot axis with increase in distance thereto from a neutral point, the neutral point being a point of contact of the cam follower on the first cam-surface segment when the pivot portion is in its neutral state.

7. The pivot mechanism according to claim 5, wherein
the cam surface is provided on the base portion,
the urging member is attached to the pivot portion,
the cam surface includes a first cam-surface segment, the first cam-surface segment coming in contact with the cam follower when the pivot angle falls in the first angular range, and
the first cam-surface segment is shaped to be reduced in distance thereto from the pivot axis with increase in distance thereto from a neutral point, the neutral point set as a point of contact with the cam follower on the first cam-surface segment in the neutral state of the pivot portion.

8. The pivot mechanism according to claim 6, wherein
the cam surface includes a second cam-surface segment, the second cam-surface segment coming in contact with the cam follower when the pivot angle falls in a second angular range greater in the pivot angle than the first angular range, and
the second cam-surface segment is configured such that when the second cam-surface segment comes in contact with the cam follower, a tangent line drawn at a point of contact with the cam follower on the second cam-surface segment is oriented orthogonal to a straight line connecting the point of contact and the pivot axis.

9. The pivot mechanism according to claim 6, wherein
the cam surface includes a second cam-surface segment, the second cam-surface segment coming in contact with the cam follower when the pivot angle falls in a second angular range greater in the pivot angle than the first angular range, and
the second cam-surface segment is shaped to be constant in distance therefrom to the pivot axis.

10. The pivot mechanism according to claim 8, wherein
the cam surface includes a third cam-surface segment, the third cam-surface segment coming in contact with the cam follower when the pivot angle falls in a third angular range between the first angular range and the second angular range,
the first cam-surface segment is made in the shape of a circular arc recessed toward the pivot axis in a view along the pivot axis, and
the third cam-surface segment is made in the shape of a circular arc bulged in a direction away from the pivot axis in the view along the pivot axis.

11. A carrying vehicle, comprising:
a carrying vehicle body including a prime mover and a drive wheel; and
the pivot mechanism recited in claim 1, the pivot mechanism attached to the carrying vehicle body.
